(19) United States
(12) Patent Application Publication
(10) Pub. No.: US 2004/0207705 A1
(43) Pub. Date: Oct. 21, 2004

(54) Three-dimensional printed image creating method and three-dimensional printed articles

(76) Inventor: Chizuo Ozawa, Shiojiri-shi (JP)

Correspondence Address: BURNS DOANE SWECKER & MATHIS L L P, POST OFFICE BOX 1404, ALEXANDRIA, VA, 22313-1404, US

(21) Appl. No.: 10/483,632

(22) PCT Filed: Mar. 6, 2003
(86) PCT No.: PCT/JP03/02680

(30) Foreign Application Priority Data
Mar. 26, 2002 (JP) 2002-085923
May 16, 2002 (JP) 2002-141099

(51) Int. Cl. B41J 2/01

(52) U.S. Cl. 347/101

(57) ABSTRACT

An image is printed on a canvas (4) using an inkjet printer (9) (step ST2). Desired portions in a printed image (11) are coated with white primer material to form a concavo-convex surface (12) corresponding to the printed image (step ST3). White paint (13) is applied on top of the concavo-convex surface (12) (step ST4), and an ink-receiving surface (14) capable of absorbing water-base ink is then formed (step ST5). The same image is reprinted at the same location using the inkjet printer (9) (step ST6). Finally, a printed image (15) is covered with a durable and water resistant protective film (16) (step ST7). Concavities and convexities are formed on the printed image (11), the same image is reprinted at the same location thereon, and a three-dimensional printed picture exhibiting the same state of concavities and convexities as an original oil painting is therefore obtained.

### TECHNICAL FIELD

The present invention relates to a method for producing three-dimensional printed images whereby three-dimensional printed images provided with surface concavities and convexities, such as in oil paintings and the like, can be produced based on photographic images and the like, and also relates to three-dimensional prints obtained by this method.

### BACKGROUND ART

In JP-A 2000-190467, the present applicant has previously proposed a large inkjet printer capable of printing on large, thick wooden panels and the like by means of an inkjet head. It is possible using this inkjet printer to easily produce signs and the like with a desired content. The applicant has also proposed a priming agent for forming an ink-receiving surface (JP-A 2000-190462), and using this priming agent makes it possible to print with the inkjet printer even onto glass, plastic, or another such water repellant surface, or cloth or another such highly water-absorbing surface. Furthermore, the applicant has proposed a surface treatment agent for protecting printed images (JP-A 2000-301707 and 2001-30615). Using this surface treatment agent makes it possible to also easily produce outdoor signs and other printed products that require durability and water resistance.

The images formed by the inkjet head discharging ink droplets are flat and smooth, and three-dimensional images with concavities and convexities in the surface, such as oil paintings or the like, cannot be printed.

Printing with expanding ink and ordinary ink for inkjet printers, as described in JP-A 2001-225459, is known as a method for forming three-dimensional images.

JP-A 2000-31814 discloses a method for forming color images with a three-dimensional feel by overlaying and printing a plurality of different images on one sheet of paper.

Furthermore, JP-A 2001-96906 discloses an invention wherein printed images that give an impression of concavities and convexities are formed by improving inkjet recording sheets for the printed images.

In addition, methods for using photosensitive resins to form concavo-convex printed images are proposed.

However, with conventional methods, it is difficult to produce a three-dimensional image in which the concavities and convexities intended by the creator are formed. For example, when a photograph of an oil painting is read by a scanner and printed onto a canvas, sections printed with expanding ink expand to form convex sections in methods using such expanding ink, but the extent of their protuberance cannot be regulated. Also, in the case of overlaid printing, it is necessary to perform image treatment whereby a photographic image that has been read is resolved into a plurality of images to allow concavities and convexities to be formed, and this kind of treatment is complicated. In addition, the extent of the concavities formed by overlaid printing is limited, thereby making it impossible to print images with an enhanced three-dimensional feel. Conversely, when the recording sheet side has concavities and convexities, these concavities and convexities do not correspond to the images, so the images produced that are far from three-dimensional images with appropriately formed concavities and convexities.

Thus, with the methods for printing and producing three-dimensional images in the prior art, it is difficult or impossible to form three-dimensional images with the desired concavities and convexities in accordance with the contents of an image.

### DISCLOSURE OF THE INVENTION

In view of these matters, a main object of the present invention is to propose a method for producing three-dimensional printed images whereby a three-dimensional image with appropriate concavities and convexities can be produced according to contents of an image being produced.

To solve the above-mentioned problems, a method for producing three-dimensional printed images of the present invention is characterized in comprising a first image-printing step wherein an image is printed using an inkjet printer on a surface of a substrate; a concavo-convex surface formation step wherein a surface with concavities and convexities is formed by attaching a primer material to the surface of the printed image; and a second image-printing step wherein the same image as the above image is reprinted using the inkjet printer at the same position on the concavo-convex surface that has been formed.

Water-base ink is common as ink used for inkjet printers, but oil-base ink (solvent ink) can also be used. When using water-base ink, it is necessary to form an ink-receiving surface for fixing the water-base ink. Specifically, it is desirable to form the ink-receiving surface on the surface of the substrate prior to the first image-printing step. It is also desirable to form a surface for receiving water-base ink on the concavo-convex surface that has been formed.

Generally, there is an image reading step for scanning and reading photographic images and the like with a scanner prior to the first image-printing step. Alternatively, it is possible to adopt an arrangement in which the photographic images or the like are read using a digital camera.

It is also desirable to include a white paint coating step for applying white paint after the concavo-convex surface formation step when it is necessary to conceal stains or the like on the concavo-convex surface that has been formed. The paint need not be white and maybe applied in layers.

It is also possible to adopt an arrangement in which a surface treatment step for coating the surface of the printed image with a surface treatment agent is included following the second image-printing step. The surface treatment agent in the surface treatment step can be an ultraviolet blocking or absorbing agent and/or a water repellant. Performing this surface treatment makes it possible to place the produced three-dimensional printed images outdoors even when the images are printed using water-base ink.

Next, in the concavo-convex surface formation step, a concavo-convex surface can be formed by one or a combination of applying a white or color coating agent; applying a primer material in paste form; affixing papier-mache; affixing collages, granular matter, or rod-shaped objects; or affixing thread. Of course, other various materials can also be used alone or in a combination.

Possible examples of the granular matter include sand, beads, sawdust, and the like, and examples of the rod-shaped objects include matchsticks and the like. Of course, solid materials other than these can also be used.

For the substrate, it is possible to use paper, wood, metal, a ceramic, cloth, a synthetic resin, rubber, leather, or the like. Of course, other materials than these maybe used, and composite materials may also be used. Furthermore, the substrates may be nails, portable phones, signs, and other products.

It is desirable that a scanner be subsequently driven in a controlled fashion by control means configured based on a personal computer to read image information in the image reading step, or that image information be read from a digital camera, and the information thus read then be printed by the inkjet printer under the control of the control means in the first and second image-printing steps.

Instead of reading photographic information or the like, an arrangement can be adopted in which an image or the like is produced by control means configured based on a personal computer, and the image is then printed by the inkjet printer.

Next, in the above-mentioned present invention, a concavo-convex surface can be formed on the surface of the substrate and an image can be printed thereon by performing the concavo-convex surface formation step prior to the first image-printing step.

Also, the present invention relates to three-dimensional prints in which images are printed in three dimensions, characterized in that the prints are produced by the above-mentioned method. Possible examples of the three-dimensional prints include three-dimensional printed pictures such as oil paintings or the like formed using photographic images, and various types of three-dimensional printed signs.

According to the method for producing three-dimensional printed images of the present invention, concavities and convexities are formed on the surface of the printed images after the images are printed on the substrate by the first image-printing step. Therefore, concavities and convexities can be formed according to the printed image. For example, specific convexities can be formed by using a brush or the like with a primer material applied to trace over the image sections of trees or the like in the printed image, or specific convexities can be formed by spraying on a coating agent with a spray gun or the like. Moreover, since the same image is reprinted at the same position by the second image-printing step after the concavo-convex surface is formed, a three-dimensional image can be formed as though it were drawn with oil painting materials.

When the concavo-convex surface is formed prior to the first image-printing step, a three-dimensional image with much variation can be produced since the concavo-convex surface is formed irrespective of the printed image.

### BRIEF DESCRIPTION OF THE DRAWINGS

FIG. 1 is a process chart showing a sequence of producing three-dimensional printed images by applying the present invention; and

FIG. 2 is an explanatory diagram showing the steps in the production sequence in FIG. 1.

### BEST MODE FOR CARRYING OUT THE INVENTION

The method for producing three-dimensional printed images by employing the present invention will be explained below with reference to the diagrams.

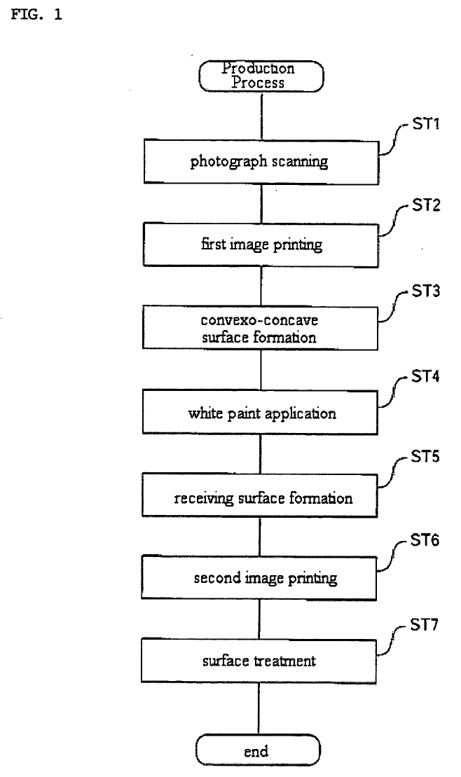

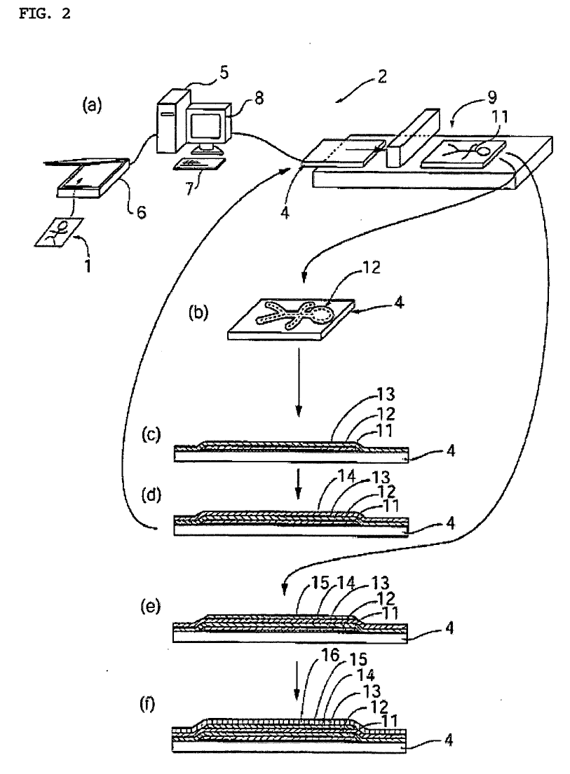

FIG. 1 is a process chart showing a sequence of producing three-dimensional printed images of the present example, and FIG. 2 is an explanatory diagram showing the production sequence involved. In a production method of the present example, a photograph 1 of an oil painting is first prepared, and the photograph 1 is then printed on a canvas 4 using an inkjet printing system 2 (step ST1 of FIG. 1: image reading step; step ST2: first image-printing step, FIG. 2(a)). The inkjet printing system 2 comprises a personal computer 5; a scanner 6 for reading images; a keyboard or other such input unit 7; a CRT, liquid crystal display device, or other such display device 8; and an inkjet printer 9. Water-base ink is common as the ink used, but oil-base ink (solvent ink) may also be used.

It is desirable that an inkjet printer produced and distributed by the applicant (product number: MMP9001R) be used herein as the inkjet printer 9. This inkjet printer can print on a surface of a medium with dimensions as large as a material thickness of 80 mm, a material width of 1118 mm, and a material length of 2000 mm.

Next, the desired convexities are applied to a surface of a printed image 11 printed on the canvas 4 to form a concavo-convex image surface 12. For example, a specific portion of the printed image 11 is made into a convex portion using a white primer material (product name: Gesso) (step ST3 of FIG. 1: concavo-convex surface formation step, FIG. 2(b)). White paint 13 is then applied to the entire surface of the canvas 4 on which the concavo-convex image surface 12 is formed (step ST4 of FIG. 1: coating step, FIG. 2(c)). It is also possible to forego this coating step.

Then, a priming agent capable of absorbing and retaining water-base ink is applied thereon, and a receiving surface 14 for water-base ink is formed (step ST5 of FIG. 1: receiving surface formation step, FIG. 2(d)). This step is not necessary when oil-base ink is used. The printed image stored in the memory of the personal computer 5 is then reprinted on the ink-receiving surface 14 of the canvas 4 using the inkjet printer 9 (step ST6 of FIG. 1: second image-printing step, FIG. 2(e)). Finally, a surface treatment agent is applied with a spray gun or the like to an entire surface of the canvas 4 on which the printed image 15 has been printed, and an ultraviolet blocking or absorbing protective film 16 is formed (step ST7: surface treatment step, FIG. 2(f)). It is desirable that the protective film 16 formed be weather resistant, water resistant, and durable. It is also possible to forego this step when using oil-base ink or when producing a three-dimensional printed picture or the like to be placed indoors.

Paperboard, wood, common metal, ceramics, cloth, leather, synthetic resins, rubber, and the like can be used in addition to the canvas as the substrate. The substrate may also be one provided with a surface that has concavities and convexities, one provided with punched metal or another such porous surface, or the like.

The image to be copied can be in the form of unaltered electronic information, and it is possible to use a photograph, such as one taken with an analog camera, a positive or negative thereof, a photograph in a magazine catalog, or the like. Of course, the image may also be produced using a personal computer.

Convexities can subsequently be formed in the surface of the printed image by various methods in the concavo-convex surface formation step. For example, papier-mache may be affixed, or convex portions may be formed by collaging. Stones, sand, beads, sawdust, and other such granular matter may be affixed by means of an adhesive. Threads, matchsticks, or the like may also be affixed.

In the concavo-convex surface formation step, primer material coating step, receiving surface formation step, and surface treatment step, a primer material or the like may be sprayed on with a spray gun, or a roll coater or the like may be used. The material may also be applied with a paintbrush.

It is desirable to use substances proposed by the applicant (those disclosed in JP-A 2000-190462, 2000-301707, and 2001-30615) as the priming agent and surface treatment agent.

### Industrial Applicability

As described above, in the method for producing three-dimensional printed images of the present invention, images are printed on the surface of a canvas or another such substrate using an inkjet printer, convexities are applied thereon to form a concavo-convex surface, and the same image is then reprinted at the same position with the inkjet printer.

Therefore, according to the method of the present invention, convexities with desired height can be formed on the desired portions in the printed image, making it possible to obtain three-dimensional prints on which three-dimensional printed images with desired convexities are formed, which is different from cases in which concavo-convex printed surfaces are merely formed, as in the prior art. For example, it is possible to easily obtain three-dimensional printed pictures that exhibit the same state of concavities and convexities as an original oil painting.

Also in the present invention, a concavo-convex surface is formed and the surface is then made into an ink-receiving surface when water-base ink is used. Therefore, the concavo-convex surface can be formed using material comprising a water repellant surface to which water-base ink does not adhere. A resulting advantage is that no limitations are imposed on the material used to form the concavo-convex surface.

Furthermore, in the present invention, white primer material is applied after the concavo-convex surface has been formed, and the image is printed on the white concavo-convex surface during the second image-printing step. Therefore, a color image corresponding to the original picture can be printed.

An additional advantage is that when surface treatment is performed, it is possible to obtain prints on which three-dimensional printed images are formed that are durable and water resistant even when placed outdoors.

1. A method for producing three-dimensional printed images, comprising:
a first image-printing step wherein an image is printed using an inkjet printer on a surface of a substrate;
a concavo-convex surface formation step wherein a surface with concavities and convexities is formed by attaching a primer material to a surface of the printed image; and
a second image-printing step wherein the same image as the above image is reprinted using the inkjet printer at the same position on the concavo-convex surface that has been formed.

2. The method for producing three-dimensional printed images according to claim 1, wherein:
the surface of the substrate is coated with a priming agent prior to the first image-printing step.

3. The method for producing three-dimensional printed images according to claim 1, further comprising:
a step wherein an ink-receiving surface for water-base ink is formed by coating the surface of the substrate with a priming agent prior to the first image-printing step, wherein
the image is printed using water-base ink in the first image-printing step.

4. The method for producing three-dimensional printed images according to claim 1, further comprising:
a receiving surface formation step for forming a surface for receiving water-base ink on the concavo-convex surface formed in the concavo-convex surface formation step, wherein
the image is printed on the receiving surface using water-base ink in the second image-printing step.

5. The method for producing three-dimensional printed images according to claim 1, further comprising:
a surface treatment step wherein a surface of the printed image formed by the second image-printing step is coated with a surface treatment agent.

6. The method for producing three-dimensional printed images according to claim 5, wherein:
the surface treatment agent is an ultraviolet blocking or absorbing agent and/or a water repellant.

7. The method for producing three-dimensional printed images according to claim 4, further comprising:
a paint coating step wherein prior to the receiving surface formation step, paint is applied to the concavo-convex surface formed during the concavo-convex surface formation step.

8. The method for producing three-dimensional printed images according to claim 1, further comprising:
an image reading step for scanning and reading a photographic image or the like with a scanner, or an image reading step for reading a photographic image or the like with a digital camera prior to the first image-printing step.

9. The method for producing three-dimensional printed images according to claim 8, wherein:
in the image reading step, either the scanner is driven in a controlled fashion by control means configured based on a personal computer to read image information, or image information is read from the digital camera; and
in the first and/or second image-printing step, the information thus read is printed by the inkjet printer under the control of the control means.

10. The method for producing three-dimensional printed images according to claim 1, wherein:
in the first and second image-printing step, information about the image or the like produced by control means configured based on a personal computer is printed by the inkjet printer.

11. The method for producing three-dimensional printed images according to claim 1, wherein:
the substrate is paper, wood, metal, ceramics, cloth, synthetic resin, rubber, or leather.

12. The method for producing three-dimensional printed images according to claim 1, wherein:
in the concavo-convex surface formation step, the concavo-convex surface is formed by one or a combination of applying a white or color paint; affixing papier-mache; affixing collages, granular matter, or rod-shaped objects; or affixing thread.

13. The method for producing three-dimensional printed images according to claim 12, wherein:
the granular matter is sand, beads, or sawdust, and the rod-shaped objects are matches.

14. The method for producing three-dimensional printed images according to claim 1, wherein:
the concavo-convex surface is formed on the surface of the substrate by performing the concavo-convex surface formation step prior to the first image-printing step.

15. Three-dimensional prints, wherein three-dimensional printed images are formed by the production method according to claim 1.
